(19) United States
(12) Patent Application Publication
(10) Pub. No.: US 2025/0237288 A1
(43) Pub. Date: Jul. 24, 2025

(54) LOAD MANAGEMENT STRIKER CAP

(71) Applicant: BASF SE, Ludwigshafen am Rhein (DE)

(72) Inventor: Sadiq Al-Dahhan, Wyandotte, MI (US)

(73) Assignee: BASF SE, Ludwigshafen am Rhein (DE)

(21) Appl. No.: 18/855,502

(22) PCT Filed: Apr. 10, 2023
(86) PCT No.: PCT/EP2023/059348

§ 371 Date: Oct. 9, 2024

Related U.S. Application Data
(60) Provisional application No. 63/329,940, filed on Apr. 12, 2022.

(30) Foreign Application Priority Data
May 30, 2022 (EP) 22176086.1

(51) Int. Cl. F16F 9/58; B60G 15/06; F16F 9/32

(52) U.S. Cl. CPC F16F 9/58; B60G 15/062; F16F 9/3242; B60G 2204/45021; B60G 2206/013; B60G 2206/81012

(57) ABSTRACT

A load management striker cap (LMSC), a method of forming the load management striker cap and a suspension system having the load management striker cap for a vehicle provide a cost-effective solution to manage a high load capacity in vehicles by absorbing surplus and extremely high energy transmitted by impact from a jounce bumper. The load management striker cap avoids transmission of the impact force to the frame of the vehicle as well as reduces failure of the suspension system components.

### FIELD OF INVENTION

The present invention relates to a load management striker cap (LMSC), a method of forming the striker cap, a suspension system with the striker cap and a vehicle comprising the same.

### BACKGROUND OF THE INVENTION

A suspension system of a vehicle engages to limit an impact force from being transmitted to a frame member of the vehicle. Components of the suspension system include a support, a striker, and a jounce bumper that absorbs energy generated by the impact force. Also, variations in loading of the vehicles beyond capacity of the suspension system as well as large wheel vehicles result in having amplified magnitude of axial loads directed to the suspension system. With the amplified axial load, the impact force generated is significant and is not dissipated by the suspension system. When the suspension system cannot completely dissipate the energy, components can impact the frame assembly of the vehicle, thereby, transmitting the impact force to the frame members, which is not desirable. Accordingly, improvement in the working of the suspension system is needed

Exceeding of maximum compression capacity of the jounce bumper results in failure of a shock tube, a shock tower and a shock mount of the suspension system. Although, adding more structural enforcements to the vehicle reduces the impact force; such additions are costly. Moreover, structural enforcements are also associated with modifications to the suspension systems.

Accordingly, there exists long felt need to provide a cost-effective solution to manage high load capacity without damaging the suspension system and the frame of the vehicle. It was, therefore, an object of the present invention to provide for an improved suspension system to manage variable axial loads without failure of other components, with least modification of the suspension system and the vehicle; and in a cost-effective manner.

### SUMMARY OF THE INVENTION

Surprisingly, it has been found that the above identified object is met by providing a load management striker cap (LMSC) for a suspension system, a method of forming the striker cap, and a suspension system for a vehicle having the striker cap. With presence of the striker cap having load management capacity on the striker surface; the striker cap absorbs surplus and extremely high energy transmitted by impact from the jounce bumper. The striker cap avoids transmission of the impact force to the frame of the vehicle as well as reduce failure of the suspension system components. The striker cap also provides for a cost-effective solution to improve the suspension without implementing any other structure modifications to the vehicle.

Accordingly, in one aspect, the presently claimed invention is directed to a striker cap (100) for mounting on a striker surface (201) of a suspension system (200), the striker cap (100) comprising:
a. a cylindrical side wall (101);
b. a roof (102) circumferentially connected to the cylindrical side wall (101), wherein the roof (102) includes a roof central aperture (103); and
c. a compression region (104) above and concentric with the roof;
wherein the compression region (104) includes at least one breathing hole (105) connecting a compression region central aperture (106) with an outer circumference (107) of the compression region, and
wherein circumferentially connected roof and the cylindrical side wall enclose at least one insert (108).

In another aspect, the presently claimed invention is directed to a method of forming the striker cap (100), wherein the method comprising:
a. providing at least one insert (108) in a mold for the striker cap (100);
b. injecting an injection molded material into the mold and over at least one insert (108);
c. optionally curing the injection molded material to form the striker cap (100);
d. releasing the striker cap (100) from the mold.

In another aspect, the presently claimed invention is directed to a suspension system (200) for a vehicle (300) having a vehicle body (301) and a movable component (302) displaceable relative to the vehicle body (301) along a line of travel, the suspension system (200) comprising:
a. a support (201) adapted to be mounted to the vehicle body (301);
b. a striker surface (202) adapted to be associated with the movable component (302) and displaceable relative to said support (201) along the line of travel;
c. a jounce bumper (203) mounted to said support and extending outwardly toward said striker surface (202); and
d. a striker cap (100) of any one of claims 1 to 9 mounted on the striker surface (202).

In another aspect, the presently claimed invention is directed to a vehicle (300) comprising:
a. the vehicle body (301);
b. the movable component (302) displaceable relative to the vehicle body (301);
c. the suspension system (200) with the striker cap (100) as claimed in claim 10.

### BRIEF DESCRIPTION OF THE FIGURES

FIG. 1 is a view of a striker cap (100a) with an insert (108a) in form of a combination unit. FIGS. 1a, 1b and 1c provide top view, vertical cross-section and bottom view respectively.

FIG. 2 is vertical cross-section view of a suspension system (200) having a striker surface (202), the striker cap (100), a piston rod (36), a jounce bumper (20). FIGS. 2a and 2b provide vertical cross section view before impact and after impact respectively.

FIG. 3 is a view of a striker cap (100b) with an insert (108b) in low trim vehicles. FIGS. 3a, 3b and 3c provide top view, vertical cross-section and bottom view respectively.

FIG. 4 is a view of a striker cap (100c) with an insert (108c). FIGS. 4a and 4b provide top view and vertical cross-section view respectively.

FIG. 5 is a perspective view of the suspension system (200) of a vehicle (300) having the striker cap (100).

FIG. 6 is a vertical cross-section view of a striker cap (100d) with an insert (108d).

FIG. 7 is a vertical cross-section view of a striker cap (100e) with an insert (108e).

FIG. 8 is a vertical cross-section view of a striker cap (100f) with an insert (108f).

FIG. 9 is a vertical cross-section view of a striker cap (100g) with an insert (108g).

FIG. 10 is a vertical cross-section view of a striker cap (100h) with an insert (108h).

FIG. 11 is a vertical cross-section view of a striker cap (100i) with an insert (108i).

FIG. 12 is a vertical cross-section view of a striker cap (100i) with an insert (108j).

### DETAILED DESCRIPTION OF THE INVENTION

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features are combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments are understood and effected by those skilled in the art in practicing a claimed invention, from a study of the drawings, the disclosure, and the dependent claims. In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the present invention will be limited only by the appended claims.

The terms “comprising”, “comprises” and “comprised of” as used herein are synonymous with “including”, “includes” or “containing”, “contains”, and are inclusive or open ended and do not exclude additional, non-recited members, elements or method steps. It will be appreciated that the terms “comprising”, “comprises” and “comprised of” as used herein comprise the terms “consisting of”, “consists” and “consists of”.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments are used in any combination.

Furthermore, the ranges defined throughout the specification include the end values as well, i.e. a range of 1 to 10 implies that both 1 and 10 are included in the range. For the avoidance of doubt, the applicant shall be entitled to any equivalents according to applicable law.

Referring to the Figures, wherein like numerals indicate like or corresponding parts throughout the several views.

### Striker Cap

An aspect of the present invention is an embodiment, directed towards a striker cap (100) for mounting on a striker surface (201) of a suspension system (200), the striker cap (100) comprising:
a. a cylindrical side wall (101);
b. a roof (102) circumferentially connected to the cylindrical side wall (101), wherein the roof (102) includes a roof central aperture (103); and
c. a compression region (104) above and concentric with the roof (102);
   wherein the compression region (104) includes at least one breathing hole (105) connecting a compression region central aperture (106) with an outer circumference (107) of the compression region, and
   wherein circumferentially connected roof and the cylindrical side wall enclose at least one insert (108).

In an embodiment, the striker cap (100) is made of an injection molded material selected from a polyurethane, thermoplastic composite, polyamides, co-polyamides, and aromatic polyamides, a thermoplastic polyurethane, or any combination thereof.

In an embodiment, the cylindrical side wall (101) is a hollow cylinder selected from shape of right circular cylinder, an oblique cylinder, an elliptic cylinder, a polygonal cylinder, a hexagonal cylinder, a truncated circular cylinder and a polyhedron. Shape, diametric width, thickness and height of the cylindrical side wall (101) is defined by the striker surface (201).

The roof (102) is circumferentially connected to the cylindrical side wall (101) and has the roof central aperture (103). The roof central aperture (103) is coaxially located and provides hollow space for a piston of the suspension system (200) to pass through.

The cylindrical side wall (101) and the roof (102) defines the internal hollow space complementary to shape of the striker surface (201).

In a preferred embodiment, the ratio of height of the cylindrical side wall (101) to the diameter of the roof (102) is in the range from 20:1 to 1:20. In a more preferred embodiment, the ratio of heigh of the cylindrical side wall (101) to the diameter of the roof (102) is in the range from 18:1 to 1:20, or from 16:1 to 1:20, or from 14:1 to 1:20, or from 12:1 to 1:20, or from 10:1 to 1:20, or from 8:1 to 1:20, or from 6:1 to 1:20, or from 4:1 to 1:20, or from 2:1 to 1:20 or from 1:1 to 1:20. In another preferred embodiment, the ratio of heigh of the cylindrical side wall (101) to the diameter of the roof (102) is in the range from 1:1 to 1:18, or from 1:1 to 1:16, or from 1:1 to 1:14, or from 1:1 to 1:12, or from 1:1 to 1:10, or from 1:1 to 1:10, or from 1:1 to 1:8, or from 1:1 to 1:6, or from 1:1 to 1:4, or from 1:1 to 1:2, or is 1:1.

The compression region (104) is located above and concentric with the roof (102). The concentric region (104) includes at least one breathing hole (105) that connects the compression region central aperture (106) with the outer circumference (107) of the compression region (104).

### Breathing Hole

The at least one breathing hole (105) influences the radial expansion of the striker cap (100). In a preferred embodiment, the at least one breathing hole (105) affect stiffness of the striker cap (100). The stiffness of the striker cap (100) is directly related to an amount of energy the striker cap (100) absorbs from the surplus energy generated by the impact force and sustained by the suspension system (200) of a vehicle (300). The stiffness of the striker cap (100) affects an amount of the impact force that is absorbed by the suspension system (200) to prevent the impact force from being transferred to the vehicle body (301). Therefore, increasing the number of the breathing holes (105) and changing a configuration of the breathing holes (105) directly affects the stiffness of the striker cap (100). In a preferred embodiment, increasing number of the breathing holes (105) generally reduces the stiffness of the striker cap (100). Additionally, increasing a size of the breathing holes (105) generally reduces the stiffness of the striker cap (100). Therefore, the stiffness of the striker cap (100) is configurable by varying the number and size of the breathing holes (105) in the compression region (104) of the striker cap (100).

In an embodiment, the stiffness of the striker cap (100) is configurable depending on the intended load bearing capacity of the vehicle (300). The striker cap (100) is configurable for low trim vehicles, high trim vehicles, vehicles with variable wheel sizes.

In an embodiment, the at least one breathing hole (105) is cavity in shape selected from slit, polyhedron, parallelepiped, prism, prismoid, prismatoid, cone, and cylinder.

In a more preferred embodiment, the at least one breathing holes (105) includes a suitable configuration selected from slit, polyhedron, parallelepiped, prism, prismoid, prismatoid, cone, cylinder, parallelograms, rhomboidal configuration, rectangular configuration, S-shaped configuration.

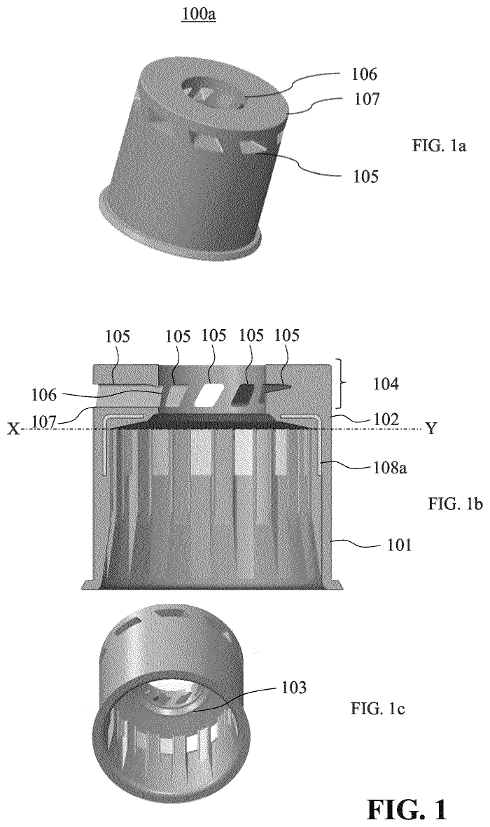

In a preferred embodiment, the at least one breathing hole (105) connecting a compression region central aperture (106) with an outer circumference (107) of the compression region (104) extends radially from jounce axis (JA) of the suspension system (200) to the perimeter of the compression region (104). See FIG. 1.

In another preferred embodiment, at least one breathing hole (105) connecting a compression region central aperture (106) originating from the roof (102) with an outer circumference (107) of the compression region extend along a height of the striker cap (100) parallel with the jounce axis JA.

In another embodiment, the at least one breathing hole (105) is a parallelogram and is rotatable such that opposite corners of the parallelograms are aligned with the jounce axis JA.

In yet another embodiment, the at least one breathing hole (105) has a S-shaped configuration.

The circumferentially connected roof (102) and the cylindrical side wall (101) encloses at least one insert (108).

### Insert

The insert (108) is a resilient material overmolded by the injection molded material to form the striker cap (100). The insert (108) is configured to be present within the striker cap (100) such that the insert (108) restricts the radial expansion of the striker cap (100) and provides structural stability.

The roof (102) encloses upper portion of the insert (108) (above the X-Y horizontal axis) while the cylindrical side wall (101) encloses the lower portion of the insert (108) (below the X-Y horizontal axis).

The insert (108) is obtainable in any shape and size. In another embodiment, the insert (108) is subjected to a surface treatment agent. The surface treatment agent is also referred to as sizing. The insert (108) when subjected to the surface treatment agent further improve the mechanical properties of the injection molded material. Typically, sizing provides adhesion between the insert (108) and the injection molded material.

In an embodiment, the insert (108) of striker cap (100) is made up of a resilient material selected from a metal, a fibre, a glass material, a wood, and hard surface sheet.

In another embodiment, the insert (108) is made up of fibre selected from metal fiber, metalized inorganic fiber, metalized synthetic fiber, glass fiber, polyester fiber, poly-amide fiber, polyvinyl alcohol fiber, aramid fiber, graphite fiber, carbon fiber, ceramic fiber, mineral fiber, basalt fiber, inorganic fiber, aramid fiber, kenaf fiber, jute fiber, flax fiber, hemp fiber, cellulosic fiber, sisal fiber and coir fiber.

In another embodiment, the insert (108) is made up of a metal selected from a chemical element, an alloy, a molecular compound.

In yet another embodiment, the insert (108) is made up of a metal selected from iron, aluminium, titanium, magnesium, copper, stainless steel, alloy steel, polymeric sulfur-nitride, polythiazyl, bronze, and tin.

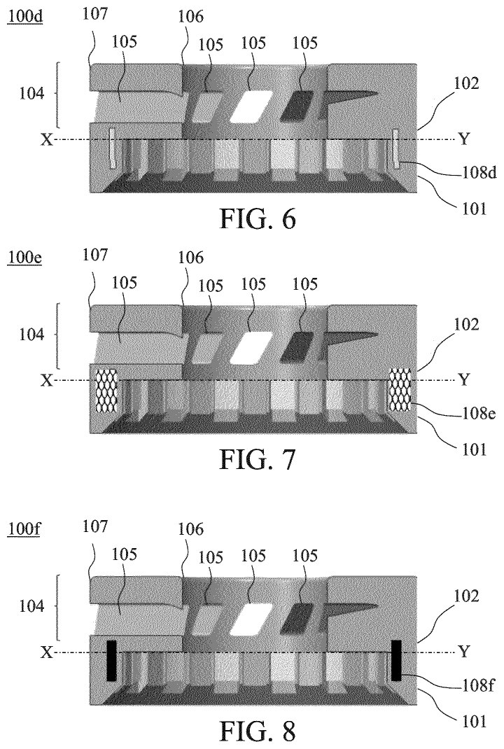

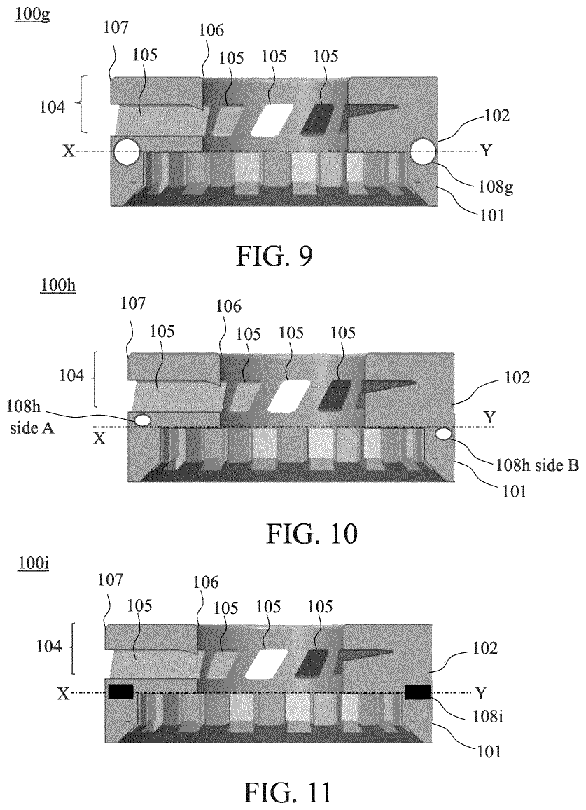

In yet another embodiment, the insert (108) is in a form selected from a disc with hole (108i) see FIG. 11, a ring (108g) see FIG. 9, a semiring (108h) see FIG. 10, a polygon, a wire, a gauze (108e) see FIG. 7, filings, cylinder (108d) see FIG. 6, a sheet (108f) see FIG. 8, or a combination unit of cylinder concentrically joined to disc with hole (108a, 108b, 108c) see FIG. 1, 3, 4 respectively.

Insert in Form of a Disc with a Hole

In a preferred embodiment, the insert (108) is a disc with hole (108i) see FIG. 11. FIG. 11 shows vertical cross section of the striker cap (100i) with the X-Y axis demarcating the roof (102) circumferentially connected to the cylindrical side wall (101).

The roof (102) encloses the upper portion of the disc with hole portion (above the X-Y horizontal axis) while the cylindrical side wall (101) encloses the lower portion (below the X-Y horizontal axis) of the disc with the hole i.e. the insert (108i). The central hole of the disc, i.e. the insert (1081) is concentric to the roof central aperture (103).

### Insert in Form of a Cylinder

In another preferred embodiment, the insert (108) is a cylinder (108d) see FIG. 6. FIG. 6 shows vertical cross section of the striker cap (100d) with the X-Y axis demarcating the roof (102) circumferentially connected to the cylindrical side wall (101).

The roof (102) encloses the upper portion of the cylinder (above the X-Y horizontal axis) while the cylindrical side wall (101) encloses the lower portion (below the X-Y horizontal axis) of the cylinder i.e. the insert (108d). The central cavity of the cylinder, i.e. the insert (108d) is concentric to the roof central aperture (103).

### Insert in Form of Combination Unit (Cylinder and Disc)

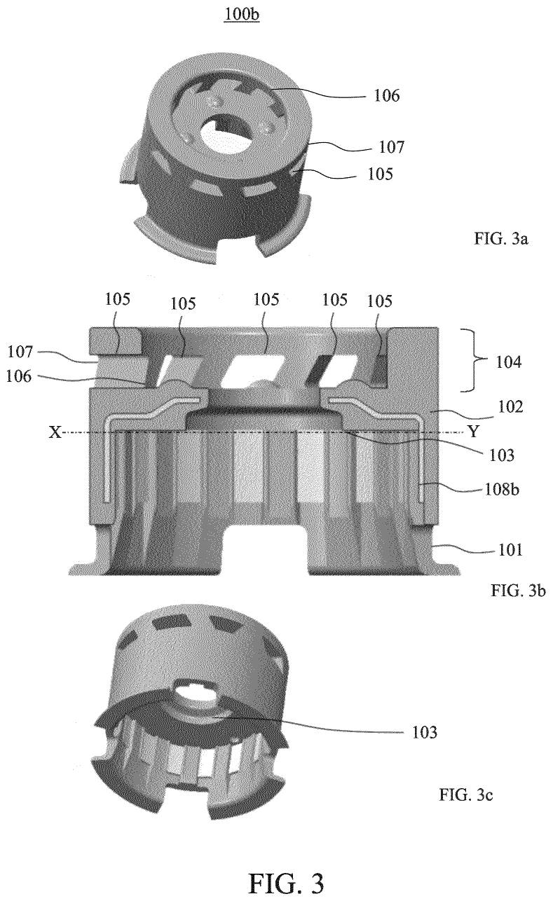

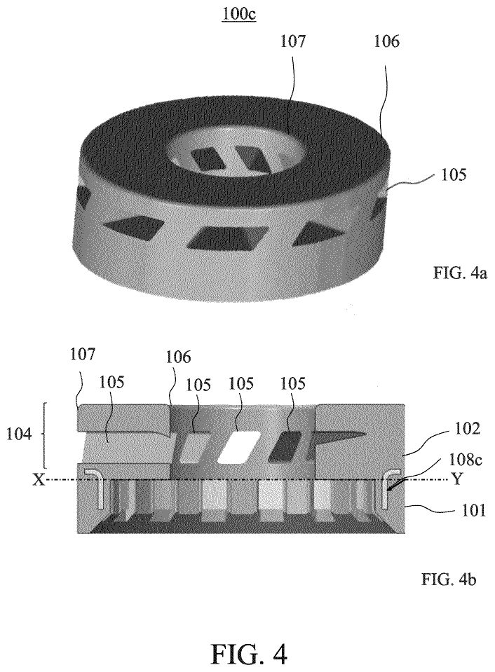

In another preferred embodiment, the insert (108) is a combination unit of cylinder concentrically joined to disc with hole (108a, 108b, 108c) see FIG. 1, 3, 4 respectively. FIGS. 1b, 3b and 4b show vertical cross section of the striker cap (100a, 100b, 100c) with the X-Y axis demarcating the roof (102) circumferentially connected to the cylindrical side wall (101).

The roof (102) encloses the disc with hole portion (above the X-Y horizontal axis) while the cylindrical side wall (101) encloses the cylinder portion of the insert (108a, 108b, 108c) (below the X-Y horizontal axis). In the insert (108a and 08b), the cylinder portion is concentrically joined to the outer end of the disc with the hole. In the insert (108c), the cylinder portion is concentrically joined to the inner end of the disc with the hole to define the central co-axial cavity.

### Insert in Form of a Gauze

In another preferred embodiment, the insert (108) is a gauze (108e) see FIG. 7. FIG. 7 shows vertical cross section of the striker cap (100e) with the X-Y axis demarcating the roof (102) circumferentially connected to the cylindrical side wall (101).

The roof (102) encloses the upper portion of the gauze (above the X-Y horizontal axis) while the cylindrical side wall (101) encloses the lower portion (below the X-Y horizontal axis) of the gauze i.e. the insert (108e). The gauze is a cylinder with perforations, thereby, central cavity of the gauze, i.e. the insert (108e) is concentric to the roof central aperture (103).

### Insert in Form of a Sheet

In another preferred embodiment, the insert (108) is a sheet (108f) see FIG. 8. FIG. 8 shows vertical cross section of the striker cap (100f) with the X-Y axis demarcating the roof (102) circumferentially connected to the cylindrical side wall (101). The sheet (108f) is a solid flat, thin piece of the resilient material.

The roof (102) encloses the upper portion of the cylinder (above the X-Y horizontal axis) while the cylindrical side wall (101) encloses the lower portion (below the X-Y horizontal axis) of the cylinder i.e. the insert (108d). The central cavity of the cylinder, i.e. the insert (108d) is concentric to the roof central aperture (103).

### Insert in Form of a Ring

In another preferred embodiment, the insert (108) is a ring (108g) see FIG. 9. FIG. 9 shows vertical cross section of the striker cap (100g) with the X-Y axis demarcating the roof (102) circumferentially connected to the cylindrical side wall (101).

The roof (102) encloses the upper portion of the ring (semi-circle above the X-Y horizontal axis), while the cylindrical side wall (101) encloses the lower portion (semi-circle below the X-Y horizontal axis) of the ring i.e. the insert (108g). The central cavity of the ring, i.e. the insert (108g) is concentric to the roof central aperture (103).

### Insert in Form of a Semi-Ring

In another preferred embodiment, the insert (108) is a semi-ring (108h) see FIG. 10. FIG. 10 shows vertical cross section of the striker cap (100g) with the X-Y axis demarcating the roof (102) circumferentially connected to the cylindrical side wall (101). The semi-ring is a disjoined ring.

The roof (102) encloses the upper portion of the ring (side A, above the X-Y horizontal axis), while the cylindrical side wall (101) encloses the lower portion (side B, below the X-Y horizontal axis) of the semi-ring i.e. the insert (108h). The central cavity of the semi-ring, i.e. the insert (108h) is concentric to the roof central aperture (103).

### Insert in Form of a Wire/Spiral

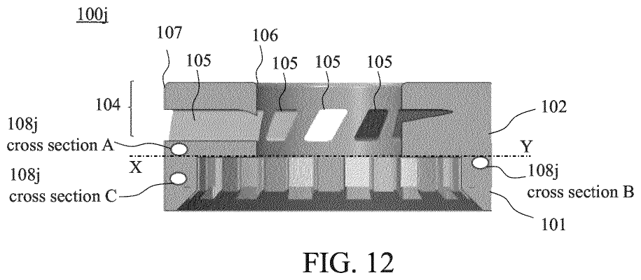

In another preferred embodiment, the insert (108) is a wire (108j) see FIG. 12. FIG. 12 shows vertical cross section of the striker cap (100j) with the X-Y axis demarcating the roof (102) circumferentially connected to the cylindrical side wall (101). The wire is formed into a spiral co-axial to the central aperture of the striker cap (100j).

The roof (102) encloses the upper portion of the ring (cross section A of the wire/spiral, above the X-Y horizontal axis), while the cylindrical side wall (101) encloses the lower portion (cross section B and C of the wire/spiral, below the X-Y horizontal axis) of the semi-ring i.e. the insert (108j). The central cavity of the wire/spiral, i.e. the insert (108j) is concentric to the roof central aperture (103).

In a preferred embodiment, the insert (108) is a stainless-steel ring (108g) or a stainless-steel disc with hole (108i), or a stainless-steel combination unit of cylinder concentrically joined to disc with hole (108a, 108b, 108c), a stainless-steel wire (108j) In a more preferred embodiment, the insert is made of steel S430 or S304.

### Method of Forming the Striker Cap

Another aspect of the present invention is to provide a method of forming the striker cap (100). The method comprises:
a. providing at least one insert (108) in a mold for the striker cap (100);
b. injecting the injection molded material into the mold and over the at least one insert (108);
c. optionally curing the injection molded material to form the striker cap (100);
d. releasing the striker cap (100) from the mold.

In an alternate embodiment after the injection molded material is injected into the mold to form the striker cap (100); the insert (108) is snap fitted into the striker cap (100).

In an embodiment, the mold is in shape complementary to the shape of the striker surface (202). The striker cap (100) is formed such that the striker cap (100) fits exactly on the striker surface (202). The mold of the striker cap (100) is also configurable to be complementary in shape of the jounce bumper (203).

The at least one insert (108) is provided in the mold of the striker cap (100). The injection molded material injected into the mold and overmolds the at least one insert (108) in shape of the striker cap (100). After injecting the injection molded material over the insert (108) in the mold, the injection molded material is optionally cured. The cured or uncured striker cap (100) is released from the mold.

In an embodiment, the injection molded material includes a polyurethane, thermoplastic composite, polyamides, co-polyamides, and aromatic polyamides, a thermoplastic polyurethane (TPU), or any combination thereof.

In a preferred embodiment, the injection molded material is a TPU.

In another embodiment, the injection molding of the method is injection overmolding. Suitable overmolding techniques for the present invention are well known to the person skilled in the art. In another embodiment, overmolding is performed by arranging a heated injection barrel with a screw shaft arranged inside and linked to a hopper containing the TPU granules. The TPU is then fed into the injection barrel where it is heated and by the action of screw shaft, injected in a molten condition through a nozzle. In a further embodiment, the plastic material is blended with the TPU and granules be injected in the molten condition through the nozzle. In one embodiment, the injection barrel has a temperature in between 210° C. to 230° C., while the nozzle has a temperature in between 220° C. to 240° C.

### Thermoplastic Polyurethane (TPU)

In an embodiment, the TPU has the shore hardness ranging from Shore D hardness of 54D to 80D, or from 60D to 80D, or from 70D to 80D.

In another embodiment, the TPU is obtained by reacting:
a. a polyol,
b. an isocyanate, and
c. optionally a chain extender.

### Polyols

Suitable polyols have an average functionality in between 1.9 to 8.0, or in between 1.9 to 6.0, or in between 1.9 to 4.0 and a hydroxyl number in between 10 mg KOH/g to 1800 mg KOH/g, or in between 10 mg KOH/g to 1500 mg KOH/g, or even between 10 mg KOH/g to 1000 mg KOH/g. The polyols are present in an amount in between 1 wt.-% to 99 wt.-%, based on the total weight of the TPU.

In one embodiment, the polyol is selected from polyether polyols, polyester polyols, polyether-ester polyols and a mixture thereof.

Polyether polyols, according to the invention, have an average functionality in between 1.9 to 8.0, or in between 1.9 to 6.0, or in between 1.9 to 4.0, or in between 1.9 to 3.0, or even in be-tween 1.9 to 2.1 and a hydroxyl number in between 10 mg KOH/g to 1800 mg KOH/g, or in be-tween 10 mg KOH/g to 1500 mg KOH/g, or in between 10 mg KOH/g to 1000 mg KOH/g, or even between 10 mg KOH/g to 500 mg KOH/g.

Suitable polyether polyols are obtainable by known methods, for example by anionic polymerization with alkali metal hydroxides, e.g., sodium hydroxide or potassium hydroxide, or alkali metal alkoxides, e.g., sodium methoxide, sodium ethoxide, potassium ethoxide or potassium isopropoxide, as catalysts and by adding at least one amine-containing starter molecule, or by cationic polymerization with Lewis acids, such as antimony pentachloride, boron fluoride etherate and so on, or fuller's earth, as catalysts from one or more alkylene oxides having 2 to 4 carbon atoms in the alkylene moiety.

Starter molecules are generally selected such that their average functionality is in between 2.0 to 8.0, or in between 3.0 to 8.0. Optionally, a mixture of suitable starter molecules is used.

Starter molecules for polyether polyols include amine containing and hydroxyl-containing starter molecules. Suitable amine containing starter molecules include, for example, aliphatic and aromatic diamines such as ethylenediamine, propylenediamine, butylenediamine, hexamethylene-diamine, phenylenediamines, toluenediamine, diaminodiphenylmethane and isomers thereof.

Other suitable starter molecules further include alkanolamines, e.g. ethanolamine, N-methylethanolamine and N-ethylethanolamine, dialkanolamines, e.g., diethanolamine, N-methyldiethanolamine and N-ethyldiethanolamine, and trialkanolamines, e.g., triethanolamine, and ammonia.

In one embodiment, amine containing starter molecules are selected from ethylenediamine, phenylenediamines, toluenediamine and isomers thereof. In other embodiment, the amine containing starter molecules comprise ethylenediamine.

Hydroxyl-containing starter molecules are selected from sugars, sugar alcohols, for e.g. glucose, mannitol, sucrose, pentaerythritol, sorbitol; polyhydric phenols, resols, e.g., oligomeric condensation products formed from phenol and formaldehyde, trimethylolpropane, glycerol, glycols such as ethylene glycol, propylene glycol and their condensation products such as polyethylene glycols and polypropylene glycols, e.g., diethylene glycol, triethylene glycol, dipropylene glycol, and water or a combination thereof.

In one embodiment, the hydroxyl-containing starter molecules comprise sugar and sugar alcohols such as sucrose, sorbitol, glycerol, pentaerythritol, trimethylolpropane and mixtures thereof. In other embodiment, the hydroxyl-containing starter molecules comprise sucrose, glycerol, pentaerythritol and trimethylolpropane.

Suitable alkylene oxides having 2 to 4 carbon atoms are, for example, ethylene oxide, propylene oxide, tetrahydrofuran, 1,2-butylene oxide, 2,3-butylene oxide and styrene oxide. Alkylene oxides are used singly, alternatingly in succession or as mixtures. In one embodiment, the alkylene oxides are propylene oxide and/or ethylene oxide. In other embodiment, the alkylene oxides are mixtures of ethylene oxide and propylene oxide that comprise more than 50 wt.-% of propylene oxide.

In one embodiment, suitable polyether polyols are derived from tetrahydrofuran. Tetrahydrofuran is a cyclic ether and is converted into a linear polymer called poly (tetramethylene ether) glycol (PTMEG) before obtaining the TPU. Commercially available polytetrahydrofuran, under the tradename PolyTHF® from BASF, can also be used.

Suitable amounts of the polyether polyols are in between 1 wt.-% to 99 wt.-%, based on the total weight of the TPU.

Suitable polyester polyols have an average functionality in between 1.9 to 6.0, or between 1.9 to 5.0, or between 1.9 to 4.0, and a hydroxyl number in between 10 mg KOH/g to 500 mg KOH/g.

Polyester polyols, according to the present invention, are based on the reaction product of carboxylic acids or anhydrides with hydroxyl group containing compounds. Suitable carboxylic ac-ids or anhydrides have from 2 to 20 carbon atoms, or from 4 to 18 carbon atoms, for example succinic acid, glutaric acid, adipic acid, suberic acid, azelaic acid, sebacic acid, decanedicarboxylic acid, maleic acid, fumaric acid, phthalic acid, isophthalic acid, terephthalic acid, oleic acid, phthalic anhydride. Particularly comprising phthalic acid, isophthalic acid, terephthalic acid, oleic acid and phthalic anhydride or a combination thereof.

Suitable hydroxyl containing compounds are selected from ethanol, ethylene glycol, propylene-1,2-glycol, propylene-1,3-glycol, butyl-ene-1,4-glycol, butylene-2,3-glycol, hexane-1,6-diol, octane-1,8-diol, neopentyl glycol, cyclohexane dimethanol (1,4-bis-hydroxy-methylcyclohexane), 2-methyl-propane-1,3-diol, glycerol, trimethylolpropane, hexane-1,2,6-triol, butane-1,2,4-triol, trimethylolethane, pentaerythritol, quinitol, mannitol, sorbitol, methyl glycoside, diethylene glycol, triethylene glycol, tetraethylene glycol, polyethylene glycol, dipropylene glycol, polypropylene glycol, polyethylene-propylene glycol, dibutylene glycol and polybutylene glycol. In one embodiment, the hydroxyl containing compounds are selected from ethylene glycol, propylene-1,2-glycol, propylene-1,3-glycol, butyl-ene-1,4-glycol, butylene-2,3-glycol, hexane-1,6-diol, octane-1,8-diol, neopentyl glycol, cyclohexane dimethanol (1,4-bis-hydroxy-methylcyclohexane), 2-methyl-propane-1,3-diol, glycerol, trimethylolpropane, hexane-1,2,6-triol, butane-1,2,4-triol, trimethylolethane, pentaerythritol, quinitol, mannitol, sorbitol, methyl glycoside and diethylene glycol. In some embodiments, the hydroxyl containing compounds are selected from ethylene glycol, propylene-1,2-glycol, propylene-1,3-glycol, butyl-ene-1,4-glycol, butylene-2,3-glycol, hexane-1,6-diol, octane-1,8-diol, neopentyl glycol and diethylene glycol. In other embodiments, the hydroxyl containing compounds are selected from hexane-1,6-diol, neopentyl glycol, diethylene glycol.

Suitable polyether-ester polyols have a hydroxyl number in between 10 mg KOH/g to 500 mg KOH/g and an average functionality in between 1.9 to 5.0.

Such polyether-ester polyols are obtainable as a reaction product of i) at least one hydroxyl-containing starter molecule; ii) of one or more fatty acids, fatty acid monoesters or mixtures thereof; iii) of one or more alkylene oxides having 2 to 4 carbon atoms.

The starter molecules of component i) are generally selected such that the average functionality of component i) is in between 1.9 to 5.0. Optionally, a mixture of suitable starter molecules are used.

In one embodiment, the hydroxyl-containing starter molecules of component i) are selected from sugars, sugar alcohols (glucose, mannitol, sucrose, pentaerythritol, sorbitol), polyhydric phenols, resols, e.g., oligomeric condensation products formed from phenol and formaldehyde, trimethylolpropane, glycerol, glycols such as ethylene glycol, propylene glycol and their condensation products such as polyethylene glycols and polypropylene glycols, e.g., diethylene glycol, triethylene glycol, dipropylene glycol, water and a mixture thereof.

In other embodiment, the hydroxyl-containing starter molecules of component i) are selected from sugars and sugar alcohols such as sucrose and sorbitol, glycerol, and mixtures of said sugars and/or sugar alcohols with glycerol, water and/or glycols such as, for example, diethylene glycol and/or dipropylene glycol.

Said fatty acid or fatty acid monoester ii) is selected from polyhydroxy fatty acids, ricinoleic acid, hydroxyl-modified oils, hydroxyl-modified fatty acids and fatty acid esters based in myristoleic acid, palmitoleic acid, oleic acid, stearic acid, palmitic acid, vaccenic acid, petroselic acid, gadoleic acid, erucic acid, nervonic acid, linoleic acid, a- and g-linolenic acid, stearidonic acid, arachidonic acid, timnodonic acid, clupanodonic acid, cervonic acid and a mixture thereof. Fatty acids are used as purely fatty acids. In this regard, preference is given to using fatty acid methyl esters such as, for example, biodiesel or methyl oleate.

Biodiesel is to be understood as meaning fatty acid methyl esters within the meaning of the EN 14214 standard from 2010. Principal constituents of biodiesel, which is generally produced from rapeseed oil, soybean oil or palm oil, are methyl esters of saturated C16 to C18 fatty acids and methyl esters of mono- or polyunsaturated C18 fatty acids such as oleic acid, linoleic acid and linolenic acid.

Suitable alkylene oxides iii) having 2 to 4 carbon atoms are, for example, ethylene oxide, propylene oxide, tetrahydrofuran, 1,2-butylene oxide, 2,3-butylene oxide and/or styrene oxide. Alkylene oxides are used singly, alternatingly in succession or as mixtures.

In one embodiment, the alkylene oxides comprise propylene oxide and ethylene oxide. In other embodiment, the alkylene oxide is a mixture of ethylene oxide and propylene oxide comprising more than 50 wt.-% of propylene oxide. In another embodiment, the alkylene oxide comprises purely propylene oxide.

### Chain Extender

In an embodiment, the chain extender has molecular weight in between 49 g/mol to 499 g/mol. In another embodiment, suitable chain extenders are selected from alkanol amines, diols and/or triols having molecular weights in between 49 g/mol to 499 g/mol. Suitable amounts of these chain extenders are known to the person skilled in the art. For instance, the chain extenders are present in an amount up to 99 wt.-%, or up to 20 wt.-%, based on the total weight of the TPU.

In one embodiment, suitable chain extenders are selected from ethylene glycol, diethylene glycol, triethylene glycol, propylene glycol, 1,3-propanediol, 1,4-butanediol, 1,5-pentanediol, 1,6-hexanediol, 1,4-butylene glycol, 1,5-pentylene glycol, methyl pentanediol, 1,6-hexylene glycol, neopentyl glycol, trimethylolpropane, glycerol, pentaerythritol, diglycerol, dextrose, 1,4:3,6 dianhydrohexitol, hydroquinone bis 2-hydroxyethyl ether and bis-2 (hydroxy ethyl)-terephthalate. In another embodiment, it are selected from triethylene glycol, propylene glycol, 1,3-propanediol, 1,4-butanediol, 1,5-pentanediol, 1,6-hexanediol, 1,4-butylene glycol, 1,5-pentylene glycol, methyl pentanediol and 1,6-hexylene glycol. In still another embodiment, it is selected from triethylene glycol, propylene glycol, 1,3-propanediol, 1,4-butanediol, 1,5-pentanediol, 1,6-hexanediol and 1,4-butylene glycol. In yet another embodiment, the chain extender comprises 1,4-butanediol.

### Isocyanate

Suitable isocyanates for the present invention comprise an aliphatic isocyanate or an aromatic isocyanate. It is to be understood that the isocyanate includes both monomeric and polymeric forms of the aliphatic and aromatic isocyanate. By the term “polymeric”, it is referred to the polymeric grade of the aliphatic and/or aromatic isocyanate comprising, independently of each other, different oligomers and homologues.

In an embodiment, the aliphatic isocyanate is selected from tetramethylene 1,4-diisocyanate, pentamethylene 1,5-diisocyanate, hexamethylene 1,6-diisocyanate, decamethylene diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, cyclobutane-1,3-diisocyanate, 1,2-, 1,3- and 1,4-cyclohexane diisocyanates, 2,4- and 2,6-methylcyclohexane diisocyanate, 4,4′- and 2,4′-dicyclohexyldiisocyanates, 1,3,5-cyclohexane triisocyanates, isocy-anatomethylcyclohexane isocyanates, isocyanatoethylcyclohexane isocyanates, bis(isocyanatomethyl)-cyclohexane diisocyanates, 4,4′-diisocyanatodicyclohexylmethane, pentamethylene 1,5-diisocyanate, isophorone diisocyanate and mixtures thereof.

In one embodiment, the aromatic isocyanate is used for obtaining the TPU in the embodiment 1. Suitable aromatic isocyanate is selected from toluene diisocyanate; polymeric toluene diisocyanate, methylene diphenyl diisocyanate and/or polymeric methylene diphenyl diisocyanate; m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-diisopropyl benzene-2,4,6-triisocyanate, tolidine diisocyanate and 1,3,5-triisopropyl benzene-2,4,6-triisocyanate.

In other embodiment, the aromatic isocyanates are selected from toluene diisocyanate; polymeric toluene diisocyanate, methylene diphenyl diisocyanate and/or polymeric methylene diphenyl diisocyanate; m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate; 1-methyl-3,5-diethylphenylene-2,4-diisocyanate. In yet other embodiment, the aromatic isocyanates comprise toluene diisocyanate; polymeric toluene diisocyanate, methylene diphenyl diisocyanate and/or polymeric methylene diphenyl diisocyanate; m-phenylene diisocyanate; 1,5-naphthalene diisocyanate; 4-chloro-1; 3-phenylene diisocyanate. In still other embodiment, the aromatic iso-cyanates are selected from toluene diisocyanate; polymeric toluene diisocyanate, methylene diphenyl diisocyanate and/or polymeric methylene diphenyl diisocyanate; m-phenylene diisocyanate. In a further embodiment, the isocyanate comprises methylene diphenyl diisocyanate and/or polymeric methylene diphenyl diisocyanate.

Methylene diphenyl diisocyanate is available in three different isomeric forms, namely 2,2′-methylene diphenyl diisocyanate (2,2′-MDI), 2,4′-methylene diphenyl diisocyanate (2,4′-MDI) and 4,4′-methylene diphenyl diisocyanate (4,4′-MDI). Methylene diphenyl diisocyanate is classified into monomeric methylene diphenyl diisocyanate and polymeric methylene di-phenyl diisocyanate referred to as technical methylene diphenyl diisocyanate. Polymeric methylene diphenyl diisocyanate includes oligomeric species and methylene diphenyl diisocyanate isomers. Thus, polymeric methylene diphenyl diisocyanate may contain a single methylene diphenyl diisocyanate isomer or isomer mixtures of two or three methylene diphenyl diisocyanate isomers, the balance being oligomeric species. Polymeric methylene diphenyl diisocyanate tends to have isocyanate functionalities of higher than 2.0. The isomeric ratio as well as the amount of oligomeric species can vary in wide ranges in these products. For instance, polymeric methylene diphenyl diisocyanate typically contain 30 wt.-% to 80 wt.-% of methylene diphenyl diisocyanate isomers, the balance being said oligomeric species. The methylene diphenyl diisocyanate isomers are often a mixture of 4,4′-methylene diphenyl diisocyanate, 2,4′-methylene diphenyl diisocyanate and very low levels of 2,2′-methylene di-phenyl diisocyanate.

In another embodiment, reaction products of isocyanates with polyols and their mixtures with other diisocyanates and polyisocyanates can also be used.

In still another embodiment, the isocyanate comprises a polymeric methylene diphenyl diisocyanate, as described hereinabove. Commercially available isocyanates available under the trade-name, such as, but not limited to, Lupranat® from BASF can also be used for the purpose of the present invention.

Suitable amounts of isocyanates are such that the isocyanate index is in between 70 to 350, or in between 80 to 300. In one embodiment, the isocyanate index is in between 80 to 200, or 80 to 150, or 90 to 140. In another embodiment, it is in between 90 to 130, or 90 to 120, or 90 to 110. The isocyanate index describes the molar ratio of NCO groups to isocyanate reactive groups (polyol and chain extender). An index of 100 relates to the ratio of 1:1.

### Other Reinforcing Agents

In one embodiment, the TPU further comprises other reinforcing agents. For the purpose of the pre-sent invention, reinforcing agent is selected from metal fiber, metalized inorganic fiber, metalized synthetic fiber, glass fiber, polyester fiber, polyamide fiber, polyvinyl alcohol fiber, aramid fiber, graphite fiber, carbon fiber, ceramic fiber, mineral fiber, basalt fiber, inorganic fiber, aramid fiber, kenaf fiber, jute fiber, flax fiber, hemp fiber, cellulosic fiber, sisal fiber and coir fiber.

In an embodiment, the reinforcing agent is obtained in any shape and size. In another embodiment, the reinforcing agent is subjected to a surface treatment agent. The surface treatment agent is also referred to as sizing. The reinforcing agent when subjected to the surface treatment agent further improve the mechanical properties of the TPU. Typically, sizing provides adhesion between the reinforcing agent and the TPU.

In another embodiment, the surface treatment agent is a coupling agent and is selected from silane coupling agent, titanium coupling agent and aluminium coupling agent.

In one embodiment, the coupling agent comprises silane coupling agent. Suitable silane coupling agents are selected from aminosilane, epoxysilane, methyltrimethoxysilane, methyltriethoxysilane, γ-glycidoxypropyltrimethoxysilane, vinyltriacetoxysilane and vinyltrimethoxysilane.

Suitable amounts of the reinforcing agent in the TPU are well known to the person skilled in the art. In one embodiment, the amount of the reinforcing agent, as described herein, is such that the weight ratio between the reinforcing agent and the TPU is in between 0.01:1.0 to 1.0:1.0.

In still another embodiment, the TPU is obtained in the presence of catalysts and/or additives. Suitable catalysts are well known to the person skilled in the art. For instance, tertiary amine and phosphine compounds, metal catalysts such as chelates of various metals, acidic metal salts of strong acids; strong bases, alcoholates and phenolates of various metals, salts of organic acids with a variety of metals, organometallic derivatives of tetravalent tin, trivalent and pentavalent As, Sb and Bi and metal carbonyls of iron and cobalt and mixtures thereof are used as catalysts.

In one embodiment, tertiary amines include, such as but not limited to, triethylamine, tributylamine, N-methylmorpholine, N-ethylmorpholine, N,N,N′,N′-tetramethylethylenediamine, pentamethyl-diethylenetriamine and higher homologues (as described in, for example, DE-A 2,624,527 and 2,624,528), 1,4-diazabicyclo (2.2.2) octane, N-methyl-N′-dimethyl-aminoethylpiperazine, bis-(dimethylaminoalkyl) piperazines, tris (dimethylaminopropyl) hexahydro-1,3,5-triazin, N,N-dimethylbenzylamine, N,N-dimethylcyclohexylamine, N,N-diethyl-benzylamine, bis-(N,N-diethylaminoethyl) adipate, N,N,N′,N′-tetramethyl-1,3-butanediamine, N,N-dimethyl-p-phenylethylamine, 1,2-dimethylimidazole, 2-methylimidazole, monocyclic and bicyclic amines together with bis-(dialkylamino) alkyl ethers, such as 2,2-bis-(dimethylaminoethyl) ether. Triazine compounds, such as, but not limited to, tris (dimethylaminopropyl) hexahydro-1,3,5-triazin can also be used.

In other embodiment, metal catalysts include, such as but not limited to, metal salts and organo-metallics comprising tin-, titanium-, zirconium-, hafnium, bismuth-, zinc-, aluminium- and iron compounds, such as tin organic compounds, preferably tin alkyls, such as dimethyltin or diethyl-tin, or tin organic compounds based on aliphatic carboxylic acids, preferably tin diacetate, tin dilaurate, dibutyl tin diacetate, dibutyl tin dilaurate, bismuth compounds, such as bismuth alkyls or related compounds, or iron compounds, preferably iron-(II)-acetylacetonate or metal salts of carboxylic acids, such as tin-II-isooctoate, tin dioctoate, titanium acid esters or bismuth-(III)-neodecanoate or a combination thereof.

The catalysts, as described hereinabove, are present in amounts up to 20 wt.-%, based on the total weight of the TPU.

In another embodiment, additives are selected from alkylene carbonates, carbonamides, pyrrolidones, fillers, flame retardants, dyes, pigments, IR absorbing materials, UV stabilizers, plasticizers, antistats, fungistats, bacteriostats, hydrolysis controlling agents, antioxidants, cell regulators and mixtures thereof. Further details regarding additives are found, for example, in the Szycher's Handbook of Polyurethanes, 2nd edition, 2013. Suitable amounts of these additives are well known to the person skilled in the art. However, for instance, the additives are pre-sent in amounts up to 20 wt.-% based on the total weight of the TPU.

### Suspension System

Another aspect of the present invention is directed to a suspension system (200) for a vehicle (300). The vehicle has a vehicle body (301) and a movable component (302) displaceable relative to the vehicle body (301) along a line of travel. The suspension system (200) comprises:
a. a support (201) adapted to be mounted to the vehicle body (301);
b. the striker surface (202) adapted to be associated with the movable component (302) and displaceable relative to said support (201) along the line of travel;
c. a jounce bumper (203) mounted to said support (201) and extending outwardly toward said striker surface (202); and
d. a striker cap (100) of any one of claims 1 to 9 mounted on the striker surface (202) and configured to interact with the jounce bumper (203).

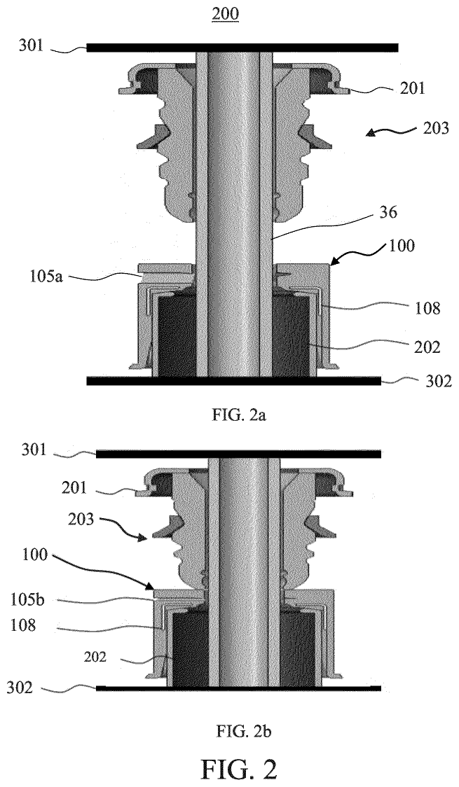

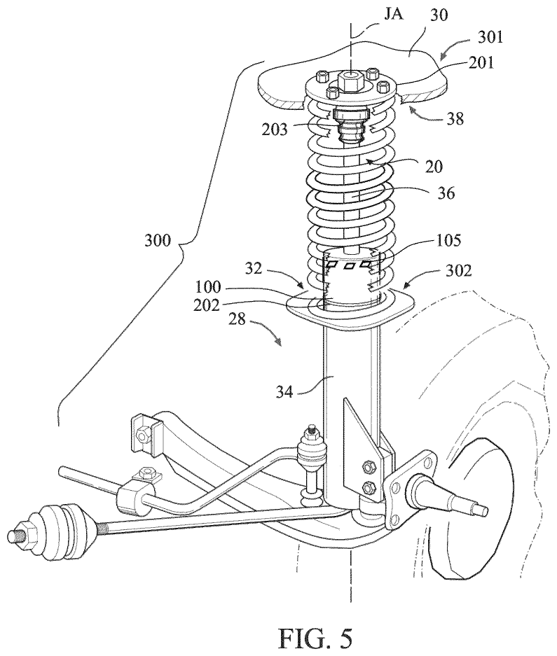

The cross section of the suspension system (200) is provided in the FIG. 2. The suspension system (200) and the vehicle (300) are further depicted in the FIG. 5.

As shown in FIGS. 2 and 5, interaction of the striker cap (100) with the jounce bumper (203) limits jounce travel between the vehicle body (301) and the movable component (302) of the vehicle (300) wherein the movable component (302) is spaced from and moveable towards the vehicle body (301) along the jounce axis (JA). For example, interaction of the striker cap (100) with the jounce bumper (203) is used with a suspension system (200) of the vehicle (300) to limit movement of the suspension system (200) towards a frame member (30) of the vehicle (300). In such an example, limiting the jounce between the suspension system (200) and the frame member (30) of the vehicle (300) limits and/or prevents transmission of an impact force experienced by the suspension system (200), such as when the vehicle (300) travels over a bump, to the frame member (30). Said otherwise, the jounce bumper (203) provides a cushion between elements of the suspension system (200) and the frame member (30) by gradually stiffening the suspension system (200) as the suspension system (200) approaches an end of its maximum jounce travel, i.e. before elements of the suspension system (200) contact the frame member (30) of the vehicle (300).

In one embodiment, interaction of the striker cap (100) with the jounce bumper (203) is in alignment with the jounce axis JA to ensure the movable component (302) contacts the jounce bumper (203) as the movable component (302) moves towards the vehicle body (301) to limit jounce.

In one embodiment, the movable component (302) is the strut assembly (32), which comprises a cylinder (34) and a piston rod (36) displaceable relative to the cylinder (34) along the jounce axis JA. An end (38) of the piston rod (36) is coupled to the vehicle body (301), which in this case is the frame member (30), for coupling the suspension system (200) to the frame member (30) of the vehicle (300). It is to be understood that striker cap (100) on the striker surface (202) and interacting with the jounce bumper (203) is disposed between any element of the vehicle (300).

Another aspect of the present invention is directed to the vehicle (300) comprising:
a. the vehicle body (301);
b. the movable component (302) displaceable relative to the vehicle body (301); and
c. the suspension system (200) with the striker cap (100).

In one embodiment, the force generated on the movable component (302) is the impact force generated in the suspension system (200) as the vehicle (300) travels over a bump. If the impact force is greater than the suspension system (200) can dampen, the components of the suspension system (200),

### Vehicle and Suspension System Articulation

When the vehicle (300) hits an obstruction, such as the curb, the impact force is generated. If the impact force is greater than the suspension system can absorb, the components of the suspension system (200) such as the cylinder (34) of the strut assembly (32) are set in motion. The striker cap (100) on the striker surface (202) associated with the movable component (302) travels along the line of travel (JA). The striker cap (100) interacts with the jounce bumper (203) that is mounted on the support (201) which in turn is mounted on the vehicle body (301).

The impact force compresses the jounce bumper (203) as seen in the FIG. 2b. The greater the impact force, the greater the compression of the bumper (203), however, when excess impact force is subjected the jounce bumper (203) or the other components of the suspension system (200) cannot absorb the surplus energy.

It is to be appreciated that the striker cap (100) provides additional load management capacity to absorb the surplus energy. The at least one breathing hole (105) facilitates the absorption of the impact force across the striker cap (100). As the striker cap (100) absorbs the surplus energy due to the impact force, the striker cap (100) undergoes compression along the line of travel and shows radial expansion. The steel insert (108) overmolded in the striker cap (100) restricts the radial expansion of the striker cap (100). Further, insert (108) provides much needed structural stability to the striker cap (100) and prevents deformation and deterioration.

The striker cap (100) interacting with the jounce bumper (203) as described herein, limits the jounce travel in the vehicle (300) body, minimises NVH, prevents suspension overtravel, is light in weight and cost effective. In particular, these advantages are attributed to the at least one breathing hole (105) and the insert (108) of the striker cap (100) obtained by overmolding the insert (108) with the injection molding material. Since the striker cap (100) are prepared in shape complementary to the striker surface (202) and the jounce bumper (203), the striker cap (100) is easily adaptable to variations of the suspension systems (200). Moreover, usage of the striker cap (100) does not require any further structural changes to be done either for the suspension system (200) or for the vehicle (300).

The presently claimed invention is illustrated in more detail by the following embodiments and combinations of embodiments which results from the corresponding dependency references and links:
I. A striker cap (100) for mounting on a striker surface (201) of a suspension system (200), the striker cap (100) comprising:
   a. a cylindrical side wall (101);
   b. a roof (102) circumferentially connected to the cylindrical side wall (101), wherein the roof (102) includes a roof central aperture (103); and
   c. a compression region (104) above and concentric with the roof;
   wherein the compression region (104) includes at least one breathing hole (105) connecting a compression region central aperture (106) with an outer circumference (107) of the compression region, and
   wherein circumferentially connected roof and the cylindrical side wall enclose at least one insert (108).
II. The striker cap of embodiment I, wherein the insert (108) is selected from a metal, a fibre, a glass material, a wood, and hard surface sheet.
III. The striker cap of embodiment I or II, wherein the insert (108) is a metal selected from a chemical element, an alloy, a molecular compound.
IV. The striker cap of any one of embodiments I to III, wherein the metal is selected from iron, aluminium, titanium, magnesium, copper, stainless steel, alloy steel, polymeric sulfur-nitride, polythiazyl, bronze, and tin.
V. The striker cap of any one of embodiments I to IV, wherein the insert (108) is in a form selected from a disc with hole (108i), a ring (108g), a semiring (108h), a polygon, a wire, a gauze (108e), filings, cylinder (108d), a sheet (108f), or combination unit of cylinder concentrically joined to disc with hole (108a, 108b, 108c).
VI. The striker cap of any one of embodiments I to V, wherein the insert (108) is a stainless-steel ring (108g) or a stain less steel disc with hole (108i), or a stainless-steel combination unit of cylinder concentrically joined to disc with hole (108a, 108b, 108c).
VII. The striker cap of any one of embodiments I to VI, wherein the at least one breathing hole (105) is cavity in shape selected from slit, polyhedron, parallelepiped, prism, prismoid, prismatoid, cone, and cylinder.
VIII. A method of forming the striker cap (100) of embodiment I, wherein the method comprising:
   a. providing at least one insert (108) in a mold for the striker cap (100);
   b. injecting an injection molded material into the mold and over the at least one insert (108);
   c. optionally curing the injection molded material to form the striker cap (100);
   d. releasing the striker cap (100) from the mold.
IX. The method of embodiment VIII, wherein the injection molded material includes a polyurethane, thermoplastic composite, polyamides, co-polyamides, and aromatic polyamides, a thermoplastic polyurethane, or any combination thereof.
X. A suspension system (200) for a vehicle (300) having a vehicle body (301) and a movable component (302) displaceable relative to the vehicle body (301) along a line of travel, the suspension system (200) comprising:
   a. a support (201) adapted to be mounted to the vehicle body (301);
   b. a striker surface (202) adapted to be associated with the movable component (302) and displaceable relative to said support (201) along the line of travel;
   c. a jounce bumper (203) mounted to said support and extending outwardly toward said striker surface (202); and
   d. a striker cap (100) of any one of embodiments I to IX mounted on the striker surface (202).
XI. A vehicle (300) comprising:
   a. the vehicle body (301);
   b. the movable component (302) displaceable relative to the vehicle body (301); and
   c. the suspension system (200) with the striker cap (100) of embodiment X.

The presently claimed invention is illustrated by the non-restrictive examples which are as follows:

RAW MATERIALS
TPU

| | |
|---|---|
| Hard TPU | Hard Thermoplastic Polyurethane |

Steel insert

| | |
|---|---|
| SS | Stainless steel S430 |
| SS a | Stainless steel S304 |

Standard Striker

| | |
|---|---|
| Stan S | Stainless steel S304 |
| Stan S | Aluminium |

STANDARD METHODS:

| | |
|---|---|
| Energy | (J) Impact machine for dynamic testing |
| | Compression load/deflection test machine for static testing |

### Forming of the Striker Cap

The steel insert (108) was made of Stainless steel S430. The steel insert (108) was prepared by stamping process. The steel insert (108) had annular ring shape. The steel insert (108) is placed in a mold/an injection molding tool and shot with TPU to make the striker cap (100).

### Testing of the Striker Cap

The striker cap (100) as per the present invention in form of the basic striker cap (100a) and the striker cap (100b) for low trim vehicles were tested along with standard steel strikers. The testing was done to determine the amount of energy absorbed by the striker caps (100a) and (100b). Table 1 and 2 denote the details for the striker caps (100a) and (100b). On comparison, it was observed that the striker cap (100a) and (100b) absorbed almost 34% and 31% more energy respectively than standard strikers.

TABLE 1
STRIKER CAP (100a)

| Sr No. | Material | Absorbed Energy (J) |
|---|---|---|
| Basic Striker cap | Hard TPU | 421.9 |
| Standard Striker | Stainless steel | 313.6 |

TABLE 2
STRIKER CAP (100b)

| | | | Initial | Block | |
|---|---|---|---|---|---|
| | | Mass | Height | Height | Absorbed |
| Sr No. | Material | (g) | (mm) | @ 45.0 kN | Energy (J) |
| Low Trim | Hard | 89.6 | 83.87 | 22.2 | 328.2 |
| Striker cap | TPU | | | | |
| Standard | Stainless | 89.6 | 84.35 | 23.3 | 249.3 |
| Striker | steel | | | | |

LIST OF REFERENCE NUMERAL

| 100 and | Striker cap |
|---|---|
| 100 (a, b, c, d, e, f, g, h, i, j) | |
| 101 | Cylindrical side wall |
| 102 | Roof |
| 103 | Roof central aperture |
| 104 | Compression region |
| 105 | Breathing hole |
| 106 | Compression region central aperture |
| 107 | Outer circumference |
| 108 and | Inserts |
| 108 (a, b, c, d, e, f, g, h, i, j) | |
| 200 | Suspension system |
| 201 | Support |
| 202 | Striker surface |
| 203 | Jounce bumper |
| 300 | Vehicle |
| 301 | Vehicle body |
| 302 | Movable component |
| 26 | Vehicle |
| 28 | Suspension system |
| 30 | Frame member |
| 32 | Strut assembly |
| 34 | Cylinder |
| 36 | Piston rod |
| 38 | End |

Obviously, many modifications and variations of the present invention are possible in light of the above teachings. The foregoing invention has been described in accordance with the relevant legal standards; thus, the description is exemplary rather than limiting in nature. Variations and modifications to the disclosed embodiment become apparent to those skilled in the art and do come within the scope of the invention. Accordingly, the scope of legal protection afforded this invention may only be determined by studying the following claims.

1. A striker cap for mounting on a striker surface of a suspension system, the striker cap comprising:
a. a cylindrical side wall;
b. a roof circumferentially connected to the cylindrical side wall, wherein the roof includes a roof central aperture; and
c. a compression region located above and concentric with the roof;
wherein the compression region includes at least one breathing hole connecting a compression region central aperture with an outer circumference of the compression region, and
wherein the circumferentially connected roof and the cylindrical side wall enclose at least one insert.

2. The striker cap according to claim 1, wherein the at least one insert is at least one material selected from the group consisting of a metal, a fibre, a glass material, a wood, and hard surface sheet.

3. The striker cap according to claim 1, wherein the at least one insert is at least one material selected from the group consisting of a chemical element, an alloy, and a molecular compound.

4. The striker cap according to claim 1, wherein the metal is selected from the group consisting of iron, aluminium, titanium, magnesium, copper, stainless steel, alloy steel, polymeric sulfur-nitride, polythiazyl, bronze, and tin.

5. The striker cap according to claim 1, wherein the at least one insert is in a form selected from the group consisting of a disc with a hole, a ring, a semiring, a polygon, a wire, a gauze, filings, a cylinder, a sheet, and a combination unit of a cylinder concentrically joined to a disc with a hole.

6. The striker cap according to claim 1, wherein the at least one insert is a stainless steel ring or a stainless steel disc with a hole, or a stainless steel combination unit of a cylinder concentrically joined to a disc with a hole.

7. The striker cap according to claim 1, wherein the at least one breathing hole is cavity in shape selected from the group consisting of a slit, polyhedron, parallelepiped, prism, prismoid, prismatoid, cone, and cylinder.

8. A method of forming the striker cap according to claim 1, the method comprising:
a. providing at least one insert in a mold for the striker cap;
b. injecting an injection molded material into the mold and over the at least one insert;
c. optionally curing the injection molded material to form the striker cap;
d. releasing the striker cap from the mold.

9. The method according to claim 8, wherein the injection molded material includes a polyurethane, thermoplastic composite, polyamides, co-polyamides, and aromatic polyamides, a thermoplastic polyurethane, or any combination thereof.

10. A suspension system for a vehicle having a vehicle body and a movable component displaceable relative to the vehicle body along a line of travel, the suspension system comprising:
a. a support adapted to be mounted to the vehicle body;
b. the striker surface adapted to be associated with the movable component and displaceable relative to said support along the line of travel;
c. a jounce bumper mounted to said support and extending outwardly toward said striker surface; and
d. a striker cap according to claim 1, mounted on the striker surface and interacting with the jounce bumper.

11. A vehicle comprising:
a. the vehicle body;
b. the movable component displaceable relative to the vehicle body; and
c. the suspension system with the striker cap according to claim 10.
